(19) United States
(12) Patent Application Publication
(10) Pub. No.: US 2002/0193002 A1
(43) Pub. Date: Dec. 19, 2002

(54) Connector structure for power supply apparatus

(76) Inventor: Chun-Chen Chen, Taoyuan (TW)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/015,345

(22) Filed: Dec. 12, 2001

(30) Foreign Application Priority Data
Jun. 19, 2001 (TW) 90210312

(51) Int. Cl. H02B 1/01

(52) U.S. Cl. 439/554

(57) ABSTRACT

A connector for a power supply apparatus comprises an insulating housing, at least two conductive terminals and at least one supporting rod, and is characterized by that the two sides of the supporting rod respectively extends downwards for a first length and a second length and stretches out to form a protruding member with a first protruding plane and a second protruding plane, wherein the first length is slightly larger than a thickness of a first circuit board and the second length is slightly larger than a thickness of a second circuit board, such that when the protruding member passes through a first pinhole on the first circuit board, the first protruding plane props against a bottom of the first circuit board, and when the protruding member passes through a second pinhole on the second circuit board, the second protruding plane props against a bottom of the second circuit board.

### FIELD OF THE INVENTION

The present invention is directed to a connector structure for a power supply apparatus.

### DESCRIPTION OF THE PRIOR ART

The power supply apparatus is mainly designed for rectifying and converting commercially available power into direct current (DC) power to power a power-receiving device. FIG. 1(a) and FIG. 1(b) respectively show an exploded view and an elevation view of a conventional power supply apparatus. The conventional power supply apparatus basically consists of an upper housing 1 and a lower housing 2. A space is defined between the upper housing 1 and the lower housing 2 for accommodating a circuit board 3 therein. A connector 4 and other necessary electronic elements 30 required by the power supply apparatus are mounted on the circuit board 3. A first concave 11 and a second concave (not shown) are respectively provided on the front side and the rear side of the upper housing 1. A third concave 21 and a fourth concave 22 respectively opposite to the first concave 11 and the second concave are respectively provided on the front side and the rear side of the lower housing 2. When the upper housing 1 and the lower housing 2 are jointed together, the first concave 11 and the third concave 21 forms a rabbet for infixing the connector 4 therein to receive external AC power. The circuitry mounted on the circuit board 3 rectify the AC power into DC power and supply the rectified DC power to power-receiving appliances such as printers, radios and modems through electric wires.

Referring to FIG. 2(a) to FIG. 2(d). The connector 4 basically includes an insulating housing 40 and two conductive terminals 42. The conductive terminals 42 are located in the through-holes inside the housing 40 and pass through the apertures on the backside of the housing (not shown) to create pins 41. Two supporting rods 43 are formed at the bottom 402 of the housing 40. Both the supporting rods 43 and the housing 40 are integrally formed by plastic injection molding technique. The two sides 431 of the supporting rod 43 respectively extends downwards from the bottom 402 of the housing 40 for a distance h and stretches out transversely to form a protruding member 433 with a protruding plane 432. The maximum transversal length d1 of the protruding member 433 is slightly larger than the width of the pinhole 32, and the length h that the supporting rod 43 extends downwards from the housing bottom 402 is slightly larger than the thickness T of the circuit board 3. Because the supporting rod 43 is made up of a plasticity material with an inherent elasticity, the protruding member 433 can pass through the pinhole 32 of the circuit board 3 by exerting an external force thereto until the protruding plane props against the bottom of the circuit board 3. The connector 4 can be fixed to the circuit board 3 accordingly.

Referring back to FIG. 1(a), the connector 4 and the circuit board 3 are connected in such a way that the two metal pins 41 are inserted into the corresponding pinhole 31 on the circuit board 3. Subsequently the protruding member 433 of the supporting rod 43 passes through the pinhole 32 on the circuit board 3 and is adequately positioned. Finally the metal pins 41 are fixed to the circuit board 3 by welding technique.

However, though the above-described way for fixing the connector 4 to the circuit board 3 can allow the connector 4 to be mounted on the circuit board 3 steadily, taking a circuit board with a thickness of 1.6 millimeter and a circuit board with a thickness of 1.2 millimeter as examples, two types of connectors each of which is of different extension length h for the supporting rod are required to fulfill the demands of matching with the circuit boards of different thickness. That signifies that two different molds are needed to manufacture the connector. Therefore the manufacturing cost for the connector will increase substantially and the amount of connectors of different specifications is not likely to be determined in advance, which causes a difficulty in the material management operation.

### SUMMARY OF THE INVENTION

An object of the present invention is the provision of a connector structure for a power supply apparatus which can be applied for circuit boards of different thickness and can be fixed to the circuit board steadily.

Another object of the present invention is the provision of a connector structure for a power supply apparatus for reducing the manufacturing cost of the connector.

A first aspect of the present invention is a presentation of a connector, which comprises an insulating housing, at least two conductive terminals and at least one supporting rod, and it is characterized by that the two sides of the supporting rod respectively extends downwards for a first length and a second length and stretches out to form a protruding member with a first protruding plane and a second protruding plane, wherein the first length is slightly larger than a thickness of a first circuit board and the second length is slightly larger than a thickness of a second circuit board, such that when the protruding member passes through a first pinhole on the first circuit board, the first protruding plane props against a bottom of the first circuit board, and when the protruding member passes through a second pinhole on the second circuit board, the second protruding plane props against a bottom of the second circuit board.

In accordance with the connector as described hereinto, the thickness of the first circuit is 1.6 millimeter, and the thickness of the second circuit board is 1.2 millimeter.

In accordance with the connector as described hereinto, the supporting rod is integrally formed with the insulating housing by a plastic injection molding technique.

In accordance with the connector as described hereinto, wherein the amount of the supporting rods of the connector is two.

Now the foregoing and other features and advantages of the present invention will be more clearly understood through the following descriptions with reference to the accompanying drawings, in which:

### BRIEF DESCRIPTION OF THE DRAWINGS

FIG. 1(a) is an exploded view showing a conventional power supply apparatus;

FIG. 1(a) is an elevation view showing a conventional power supply apparatus;

FIG. 2(a) is a perspective view of a connector for a power supply apparatus of the prior art;

FIG. 2(b) is a backside view of a connector for a power supply apparatus of the prior art;

FIG. 2(c) is a schematic chart illustrating how the supporting rod of the connector is inserted into the pinhole on the circuit board according to the prior art;

FIG. 2(d) is a schematic chart illustrating how the supporting rod of the connector is positioned onto the circuit board according to the prior art;

FIG. 3(a) is a schematic diagram illustrating how the supporting rod of the connector is inserted into a pinhole on a first circuit board of a thickness T₁ according to the present invention;

FIG. 3(b) is a schematic diagram illustrating how the supporting rod of the connector is positioned onto a first circuit board of a thickness T₁ according to the present invention;

FIG. 3(c) is a schematic diagram illustrating how the supporting rod of the connector is inserted into a pinhole on a second circuit board of a thickness T₂ according to the present invention; and

FIG. 3(d) is a schematic diagram illustrating how the supporting rod of the connector is positioned onto a second circuit board of a thickness T₂ according to the present invention.

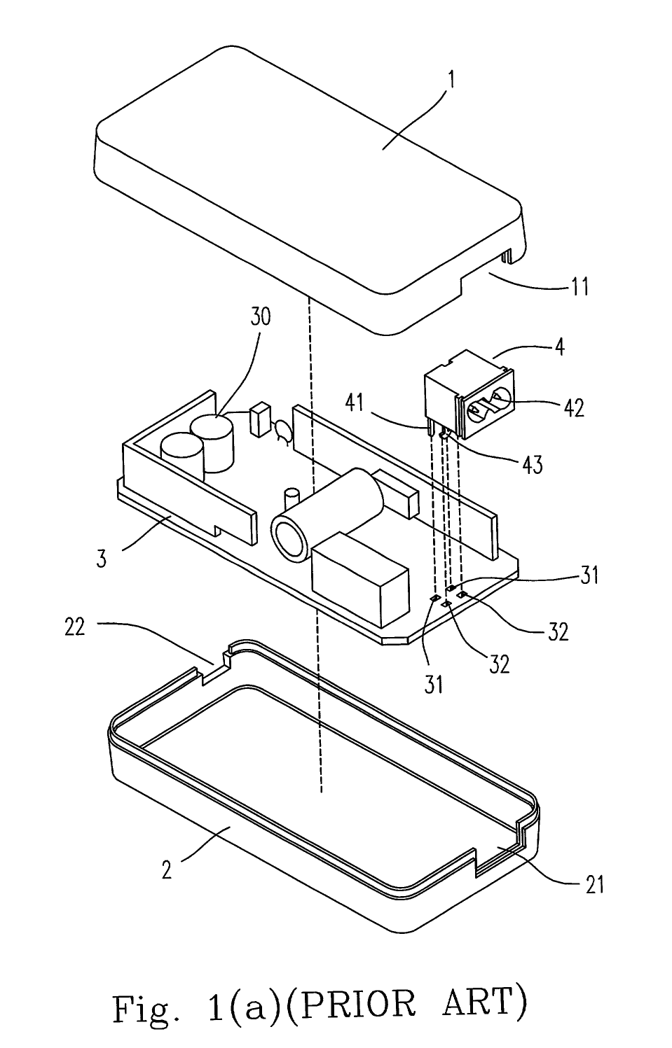

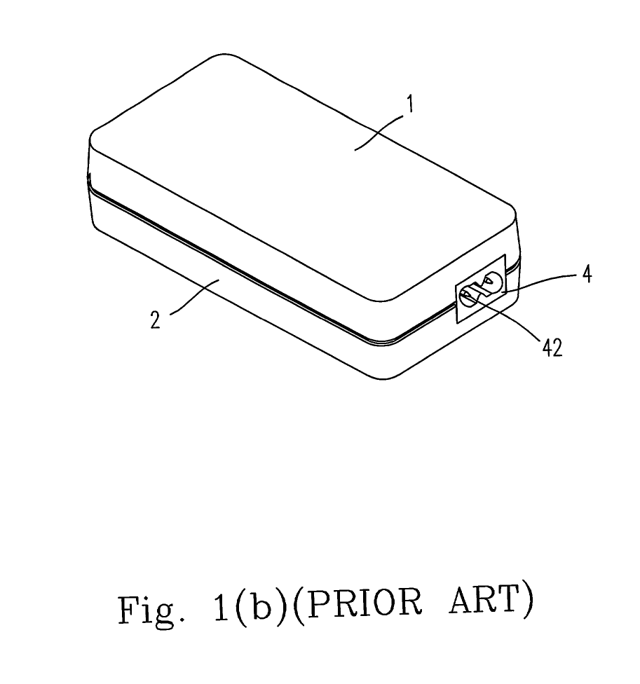

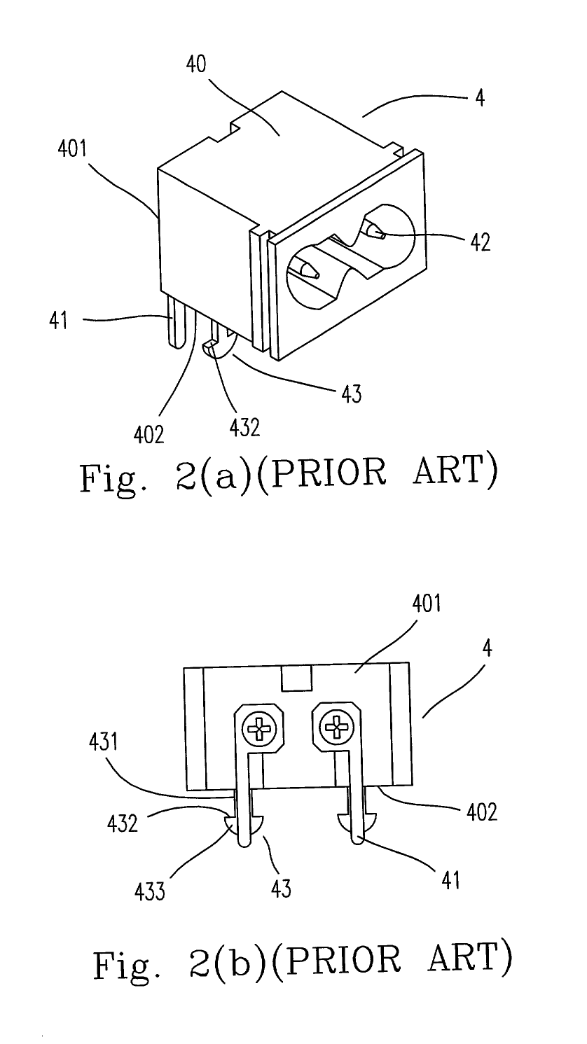

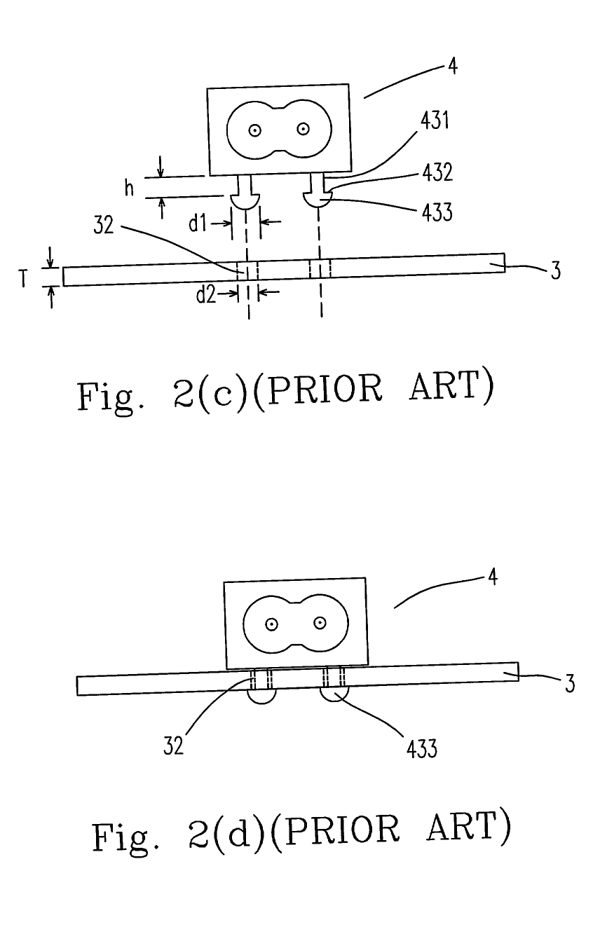

### DETAILED DESCRIPTION OF THE PREFERRED EMBODIMENT

An exemplary embodiment of the present invention now will be fully described with reference to the following preferred embodiment. It is to be emphasized that the following descriptions of embodiments and examples of the present invention is only illustrative, and it is not intended to be exhaustive or not to be limited to the precise form disclosed.

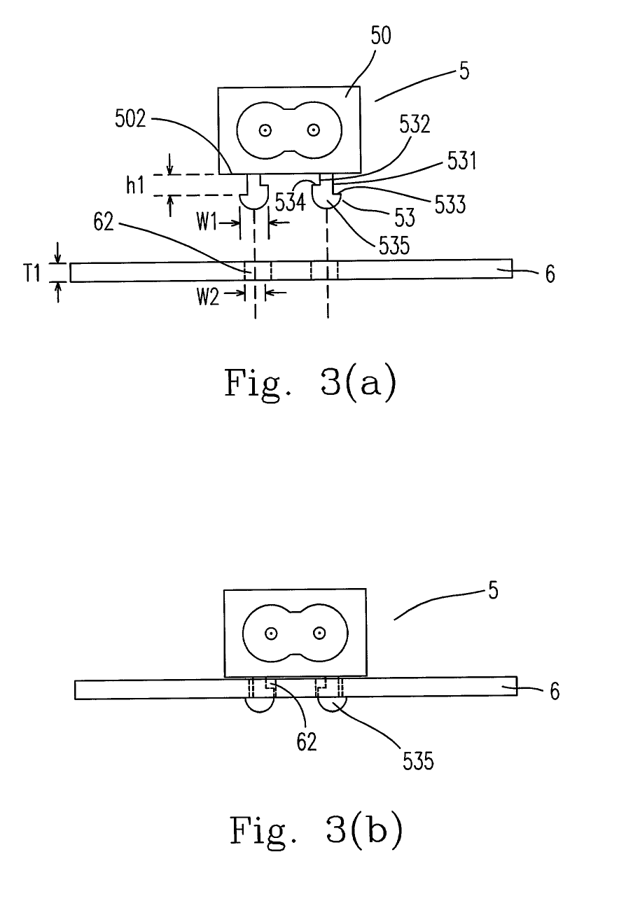

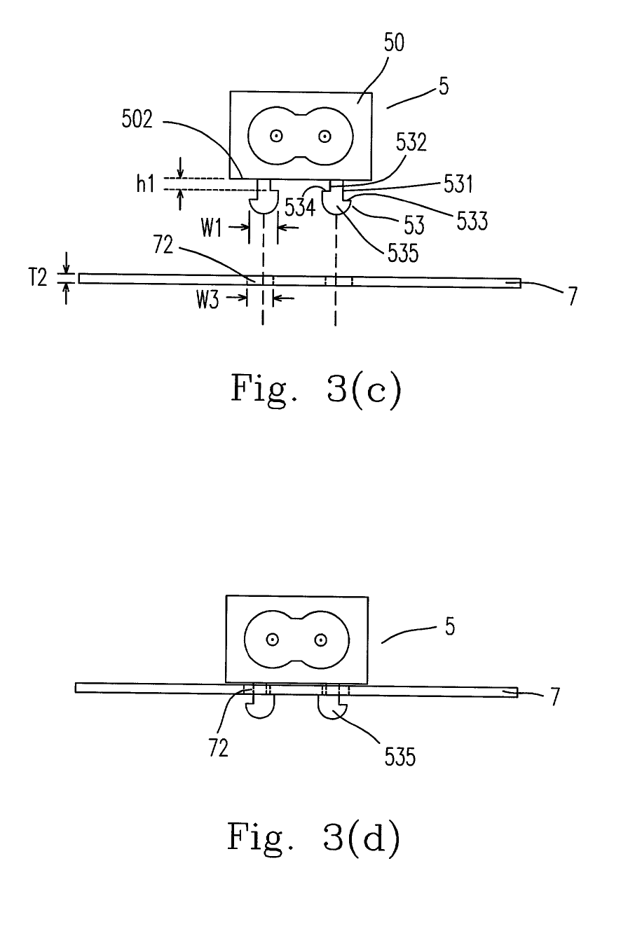

FIG. 3(a) and FIG. 3(b) are schematic diagrams respectively illustrating how the supporting rod of the connector is inserted into a pinhole on a first circuit board 6 of a thickness T₁ according to the present invention and how the supporting rod of the connector is positioned onto the first circuit board 6 of a thickness T₁ according to the present invention. FIG. 3(c) and FIG. 3(d) are schematic diagrams respectively illustrating how the supporting rod of the connector is inserted into a pinhole on a second circuit board 7 of a thickness T₂ according to the present invention and how the supporting rod of the connector is positioned onto the second circuit board 7 of a thickness T₂ according to the present invention. Two supporting rods 53 are formed at the bottom 502 of the housing 50 of the connector 5. The supporting rods 53 are integrally formed with the housing 5 with plastic injection molding technique. Two sides 531 and 532 of the supporting rod 53 respectively extends downwards for a first length h₁ and a second length h₂ and then stretches out to form a protruding member 535 with a first protruding plane 533 and a second protruding plane 534. In the present embodiment, the first length h₁ is slightly larger than the thickness T₁ of the first circuit board 6, and the second length h₂ is slightly larger than the thickness T₂ of the second circuit board 7. More preferably, the thickness T₁ of the first circuit board 6 is 1.6 millimeter, and the thickness T₂ of the second circuit board 7 is 1.2 millimeter.

Certainly, the position and dimension of the pinhole 62 on the first circuit board 6 and the pinhole 72 on the second circuit board 7 has to be dynamically modulated. The maximum transversal length W₁ of the protruding member 535 is slightly larger than the width W₂ of the pinhole 62 on the first circuit board 6 and the width W₃ of the pinhole 72 on the second circuit board 7. In FIG. 3(a) and FIG. 3(b), by exerting an external force thereto the protruding member 535 can pass through the pinhole 62 on the first circuit board 6 due to its elasticity, such that the first protruding plane 533 can prop against the bottom of the first circuit board 6 and the connector 5 can be fixed to the first circuit board 6. By the same token, in FIG. 3(c) and FIG. 3(d), by exerting an external force thereto the protruding member 535 can pass through the pinhole 72 on the second circuit board 7 due to its elasticity, such that the second protruding plane 534 can prop against the bottom of the second circuit board 7 and the connector 5 can be fixed to the second circuit board 7.

Certainly, the supporting rod of the connector of the present invention can not only fit for the connector with two conductive terminals, but can fit for the connector with three conductive terminals (with a conductive terminal is designated as a ground terminal).

Of course, the amount of the supporting rod of the connector according to the present invention can be one or more than two, wherein two is the most preferable.

In conclusion, the connector of the present invention adopts a particular supporting rod arrangement, and thereby the connector of the present invention can be positioned and fixed onto the circuit boards of different thickness. As a result, only a connector is required for two circuit boards each of which is of a different thickness. By way of standardizing the supporting rod arrangement, the objectives of reducing manufacturing cost of the connector and improving the efficiency of material management operation can be achieved with ease.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A connector for a power supply apparatus, comprising an insulating housing, at least two conductive terminals and at least one supporting rod, and characterized by that two sides of said supporting rod respectively extends downwards for a first length and a second length and stretches out to form a protruding member with a first protruding plane and a second protruding plane, wherein said first length is slightly larger than a thickness of a first circuit board and said second length is slightly larger than a thickness of a second circuit board, such that when said protruding member passes through a first pinhole on said first circuit board, said first protruding plane props against a bottom of said first circuit board, and when said protruding member passes through a second pinhole on said second circuit board, said second protruding plane props against a bottom of said second circuit board.

2. The connector according to claim 1 wherein said thickness of said first circuit board is 1.6 millimeter.

3. The connector according to claim 1 wherein said thickness of said second circuit board is 1.2 millimeter.

4. The connector according to claim 1 wherein said supporting rod is integrally formed with said insulating housing.

5. The connector according to claim 1 wherein both said supporting rod and said housing are formed of a plastic injection molding technique.

6. The connector according to claim 1 wherein an amount of said supporting rod is two.
